(19) United States
(12) Patent Application Publication
(10) Pub. No.: US 2025/0315274 A1
(43) Pub. Date: Oct. 9, 2025

(54) COMMAND PROCESSING METHODS, AND ELECTRONIC SYSTEM USING THE METHODS

(71) Applicant: Mediatek Inc., Hsin-Chu (TW)

(72) Inventors: Chin-Chin Cheng, Hsinchu City (TW); Tzu-Shiun Liu, Hsinchu City (TW)

(73) Assignee: Mediatek Inc., Hsin-Chu (TW)

(21) Appl. No.: 18/628,810

(22) Filed: Apr. 8, 2024

(51) Int. Cl. G06F 9/445

(52) U.S. Cl. CPC G06F 9/44552

(57) ABSTRACT

A command processing method, applied to an electronic system which can execute commands and comprises a plurality of storage regions. The command processing method comprises: (a) storing at least one command to at least one of the storage regions; (b) acquiring abort information of a target command among the command if the target command is already fetched from the storage regions but is to be aborted; (c) checking if the abort information and the target command are from an identical one of the storage regions; and (d) aborting the target command if a result of the step (c) is yes, and not aborting the target command if the result of the step (c) is no.

### BACKGROUND

In a conventional command processing procedure, the command may be aborted according to abort information stored in a submission queue. However, if the abort information stored in a submission queue can be used for aborting commands output by other submission queues, some issues may occur. For example, the state of tasks of the other submission queues are unclear, thus unexpected behavior in the command abort operations may be caused. For another example, malicious programs may cancel all commands by such mechanism, thus information security of electronic system is endangered. Accordingly, a new command processing method is needed.

### SUMMARY

One objective of the present application is to provide a command processing method which can prevent a command from being aborted according to information stored in a different submission queue.

Another objective of the present application is to provide an electronic system which can prevent a command being aborted according to information stored in a different submission queue.

One embodiment of the present application discloses a command processing method, applied to an electronic system which can execute commands and comprises a plurality of storage regions. The command processing method comprises: (a) storing at least one command to at least one of the storage regions; (b) acquiring abort information of a target command among the command if the target command is already fetched from the storage regions but is to be aborted; (c) checking if the abort information and the target command are from an identical one of the storage regions; and (d) aborting the target command if a result of the step (c) is yes, and not aborting the target command if the result of the step (c) is no.

Another embodiment of the present application discloses a plurality of storage regions and a processing circuit. The processing circuit is configured to perform: (a) storing at least one command to at least one of the storage regions; (b) acquiring abort information of a target command among the command if the target command is already fetched from the storage regions but is to be aborted; (c) checking if the abort information and the target command are from an identical one of the storage regions; and (d) aborting the target command if a result of the step (c) is yes, and not aborting the target command if the result of the step (c) is no.

In one embodiment, the electronic system follows the UFS 4.0 standard. In such embodiment, the storage regions are submission queues for storing the command, and the submission queues SQ1 . . . SQn may be comprises in a multi-circular queue. Further, in such embodiment, the storage regions respectively comprise a register, and the abort information is from one of the registers.

In view of above-mentioned embodiments, the command could not be aborted by a different storage region. Accordingly, the issues stated in the related art can be avoided.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic system according to one embodiment of the present application.

FIG. 2 and FIG. 3 are more detail schematic diagrams illustrating an electronic system according to one embodiment of the present application.

FIG. 4 is a schematic diagram illustrating the command UPIU contained in the command, according to one embodiment of the present application.

FIG. 5 is a flow chart illustrating the operations of the electronic system in FIG. 2, according to one embodiment of the present application.

FIG. 6 is a flow chart illustrating a command processing method according to one embodiment of the present application.

### DETAILED DESCRIPTION

Several embodiments are provided in following descriptions to explain the concept of the present application. The method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

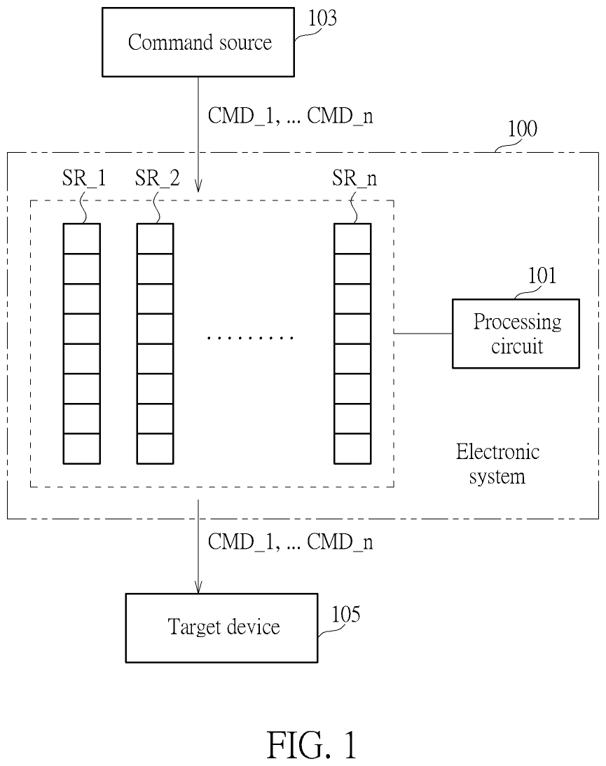

FIG. 1 is a schematic diagram illustrating an electronic system 100 according to one embodiment of the present application. As illustrated in FIG. 1, the electronic system 100 comprises a processing circuit 101 and a plurality of storage regions SR_1, SR_2 . . . SR_n. The processing circuit 101, such as a processor or a controller, is configured to control operations of the storage regions SR_1, SR_2 . . . SR_n. Also, the storage regions SR_1, SR_2 . . . SR_n are configured to receive the commands CMD_1 . . . CMD_n and to output the commands CMD_1 . . . CMD_n to the target device 105. In one embodiment, the storage regions SR_1, SR_2 . . . SR_n are in a memory device, such as a DRAM. Further, in one embodiment, the target device 105 may only receive commands with a limited number.

At least one of commands CMD_1 . . . CMD_n from the command source 103 is stored to at least one of the storage regions SR_1, SR_2 . . . SR_n. For example, four of the commands CMD_1 . . . CMD_n are stored into the storage region SR_1. For another example, four out of the commands CMD_1 . . . CMD_n are stored into the storage region SR_2, and five out of the commands CMD_1 . . . CMD_n are stored into the storage region SR_2. In one embodiment, all commands CMD_1 . . . CMD_n are respectively stored to at least one of the storage regions SR_1, SR_2 . . . SR_n.

During the procedure of processing commands, some commands may need to be aborted. In one embodiment, if the command to be aborted (in following descriptions, named as a target command) is already output to the target device 105 and has been processed by the target device 105, the target command could not be aborted thus no further processing is needed. In another embodiment, if the target command is still in the storage regions SR_1, SR_2 . . . SR_n, the target command may be marked thereby the target device 105 will not process the target command. If the target command is already fetched from the storage regions SR_1 . . . SR_n, the processing circuit 101 needs to acquire abort information of the target command to perform the command aborting operation.

Afterwards, the processing circuit 101 checks if the abort information and the target command are from an identical one of the storage regions. If yes, the target command is aborted, if not, the target command is not aborted. In one embodiment, the processing circuit 101 stops fetching the command from the storage regions SR_1, SR_2 . . . SR_n until abort operation is completed if the abort information and the target command are from an identical one of the storage regions, such that the states of the commands will not be affected due to the command abort operation. However, in another embodiment, the processing circuit 101 may not stop fetching the command from all of the storage regions SR_1, SR_2 . . . SR_n. Instead, it may stop fetching the command from the associated one of the storage regions SR_1, SR_2 . . . SR_n.

In another embodiment, the processing circuit 101 stops transmitting new commands to the target device 105 until abort operation is completed if the abort information and the target command are from an identical one of the storage regions, such that the states of the commands will not be affected due to the command abort operation. In another embodiment, if the abort information and the target command are from different storage regions, the target command is not aborted, thus the target command is transmitted to the target device 105 and being processed by the target device 105. Further, after the target command is aborted, the processing circuit 101 cleans up the resources related with the target command.

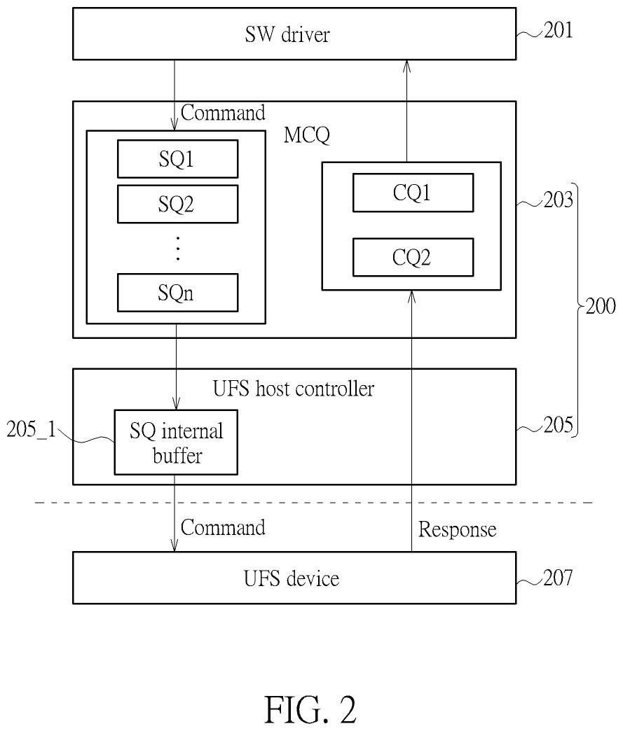

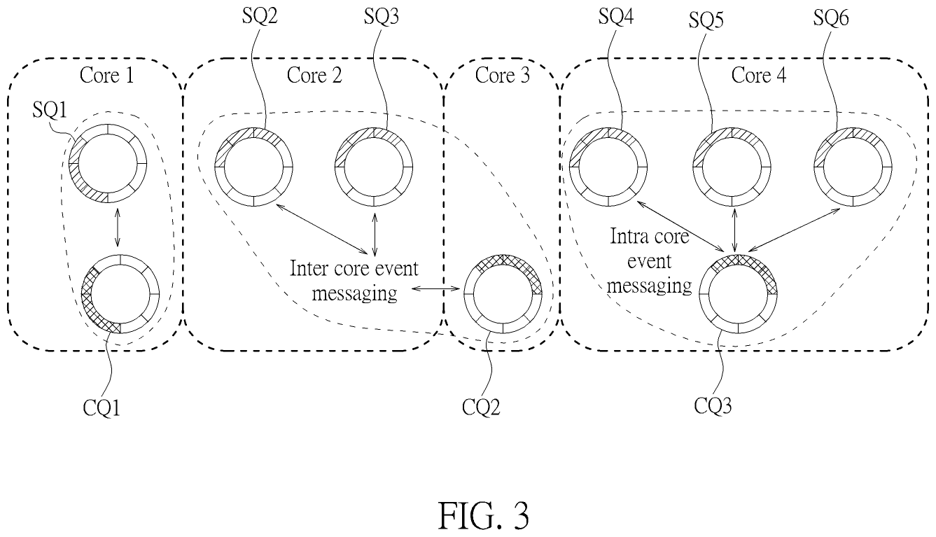

The electronic system 100 in FIG. 1 may follow various transmission standards. In one embodiment, the electronic system 100 follows UFS 4.0 standard, as shown in FIG. 2 and FIG. 3. FIG. 2 and FIG. 3 are more detail schematic diagrams illustrating an electronic system according to one embodiment of the present application. In the embodiment of FIG. 2, the command source 103 is implemented by software driver 201, the storage regions SR_1, SR_2 . . . SR_n are submission queues SQ1, SQ2 . . . SQn contained in a multi-circular queue 203. The submission queues SQ1, SQ2 . . . SQn are configured to store the commands. Also, the control circuit 101 in FIG. 1 is implemented by a UFS host controller 205, which comprises a SQ internal buffer 205_1 for buffering commands from the submission queues SQ1, SQ2 . . . SQn. Further, the target device 105 in FIG. 1 is implemented by a UFS device 207. In one embodiment, each of the submission queues SQ1, SQ2 . . . SQn respectively comprises a register, and the abort information is from such registers.

The target device 105 may generate responses after receives and processes commands. In one embodiment, the multi-circular queue 203 further comprises at least one completion queue for storing the responses. In the embodiment of FIG. 2, two completion queues CQ1, CQ2 are comprised in the multi-circular queue 203. Also, in the embodiment of FIG. 2, the completion queue CQ1 corresponds to two submission queues SQ1, SQn and the completion queue CO2 corresponds to one submission queue SQ2. That is, the completion queue CQ1 receives responses of commands in the submission queues SQ1, SQn, and the completion queue CQ2 receives responses of commands in the submission queues SQ2. However, the number of the completion queues, and corresponding relations between the submission queues and the completion queues are not limited to the example in FIG. 2.

In one embodiment, the electronic system 200 illustrated in FIG. 2 may be used for multi cores. As shown in FIG. 3, the submission queue SQ1 and the completion queue CQ1 are used for core 1, the submission queues SQ2, SQ3 and the completion queue CQ2 are used for core 2 and core 3. Besides, the submission queues SQ4, SQ5, SQ6 and the completion queue CQ3 is used for core 4.

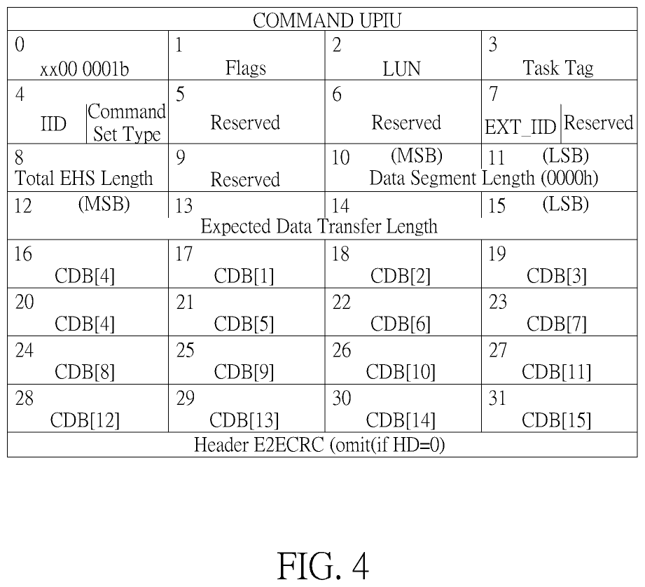

The above-mentioned step of “checking if the abort information and the target command are from an identical one of the storage regions” may be implemented by various methods. In one embodiment, the processing circuit 101 writes storage region information to the command while storing the command to the submission queues SQ_1 . . . SQ_n. For example, the processing circuit 101 writes storage region information to UPIU header contained in the command. FIG. 4 is a schematic diagram illustrating the command UPIU contained in the command, according to one embodiment of the present application. The command UPIU contains the basic UPIU header plus additional information needed to specify a command. The initiator device will generate the command UPIU and send it to request a SCSI command service to be performed by the target device.

In the embodiment of FIG. 4, the command follows UFS 4.0 standard. The above-mentioned storage region information may be written to EXT IID or IID, which may comprises information of a host which generates the commands or core number which the submission queues SQ_1 . . . SQ_n correspond to. Also, the storage region information may be written to a reserved region in the command, which is marked by “Reserved” in FIG. 4. In another embodiment, the processing circuit 101 records storage region information for each command, and checks if the abort information and the target command are from the identical one of the storage regions according to the storage region information. The storage region information may comprise for example, the number of the submission queue, thereby the processing circuit 101 can know which one of the submission queues does the command come from.

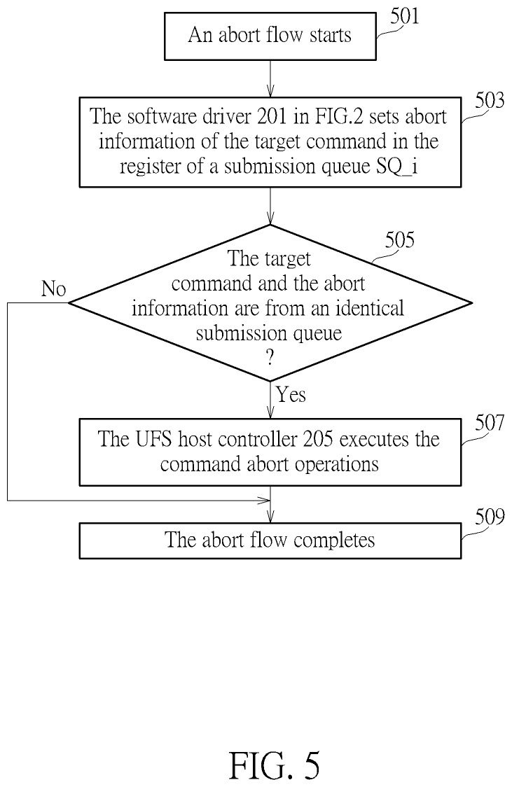

FIG. 5 is a flow chart illustrating the operations of the electronic system in FIG. 2, according to one embodiment of the present application. However, the flow in FIG. 5 may be used to an electronic system which follows a transmission standard besides UFS 4.0. The flow chart in FIG. 5 comprises following steps:

### Step 501

An abort flow starts.

### Step 503

The software driver 201 in FIG. 2 sets abort information of the target command in the register of a submission queue SQ_i.

### Step 505

The UFS host controller 205 checks if the target command and the abort information are from an identical submission queue.

If yes, go to step 507, if not, go to step 509.

### Step 507

The UFS host controller 205 executes the command abort operations.

### Step 509

The command abort completes.

In one embodiment, each of the submission queues comprises entries which have a head and a tail. The entries are configured to store commands. The command before the head means the command has been fetched by the UFS host controller 205 and the tails means a final command. In such case, the commands between the head and the tail mean the commands stored in the submission queue but not been fetched.

In view of above-mentioned embodiments, a command processing method is acquired, which is applied to an electronic system which can execute commands and comprises a plurality of storage regions.

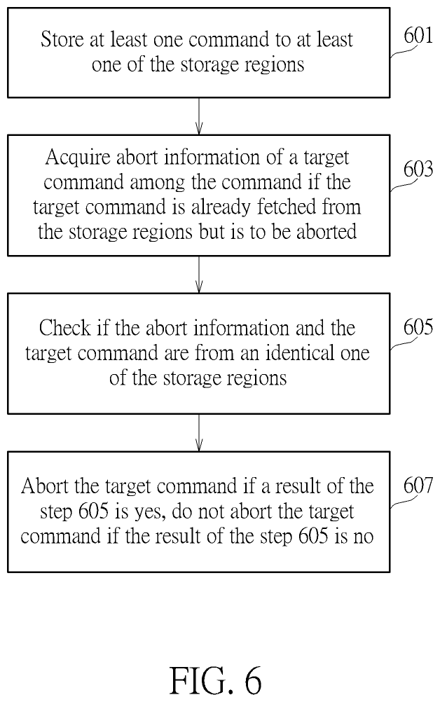

The flow chart in FIG. 6 comprises the steps of:

### Step 601

Store at least one command to at least one of the storage regions (e.g., the storage regions SR_1, SR_2 . . . SR_n in FIG. 1).

### Step 603

Acquire abort information of a target command among the command if the target command is already fetched from the storage regions but is to be aborted.

### Step 605

Check if the abort information and the target command are from an identical one of the storage regions.

### Step 607

Abort the target command if a result of the step 605 is yes, and do not abort the target command if the result of the step 605 is no.

In one embodiment, the electronic system follows the UFS 4.0 standard. In such embodiment, the storage regions are submission queues for storing the command, such as the submission queues SQ1 . . . SQn in FIG. 2, and the submission queues SQ1 . . . SQn may be comprises in a multi-circular queue (e.g., the multi-circular 203 in FIG. 2). Further, in such embodiment, the storage regions respectively comprise a register, and the abort information is from one of the registers. Other detail steps may be acquired in view of above-mentioned descriptions, thus are omitted for brevity here.

In view of above-mentioned embodiments, the command could not be aborted by a different storage region. For example, if the target command from a storage region SR_1, it can be aborted according to the abort information in the storage region SR_1, but could not be aborted according to the abort information in any one of the storage regions SR_2 . . . SR_n. Accordingly, the issues stated in the related art can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A command processing method, applied to an electronic system which can execute commands and comprises a plurality of storage regions, comprising:
(a) storing at least one command to at least one of the storage regions;
(b) acquiring abort information of a target command among the command if the target command is already fetched from the storage regions but is to be aborted;
(c) checking if the abort information and the target command are from an identical one of the storage regions; and
(d) aborting the target command if a result of the step (c) is yes, and not aborting the target command if the result of the step (c) is no.

2. The command processing method of claim 1, wherein the electronic system follows UFS 4.0 standard.

3. The command processing method of claim 2, wherein the storage regions are submission queues for storing the command.

4. The command processing method of claim 3, further comprising a multi-circular queue comprising the storage regions.

5. The command processing method of claim 2, wherein the storage regions respectively comprise a register, and the abort information is from one of the registers.

6. The command processing method of claim 1,
wherein the step (a) writes storage region information to the command while storing the command to the storage regions;
wherein the step (c) checks if the abort information and the target command are from the identical one of the storage regions according to the storage region information.

7. The command processing method of claim 1, further comprising:
recording storage region information for each one of the command by a processing circuit which controls the storage region;
wherein the step (c) checks if the abort information and the target command are from the identical one of the storage regions according to the storage region information.

8. The command processing method of claim 1, wherein the step (d) further comprises:
stopping fetching the command from the storage regions or stopping transmitting the command to the target device, if the result of the step (c) is yes.

9. The command processing method of claim 1, wherein the step (d) further comprises:
transmitting the target command to a target device and processing the target command by the target device if the result of the step (c) is no.

10. An electronic system, comprising:
a plurality of storage regions; and
a processing circuit, configured to perform:
(a) storing at least one command to at least one of the storage regions;
(b) acquiring abort information of a target command among the command if the target command is already fetched from the storage regions but is to be aborted;
(c) checking if the abort information and the target command are from an identical one of the storage regions; and
(d) aborting the target command if a result of the step (c) is yes, and not aborting the target command if the result of the step (c) is no.

11. The electronic system of claim 10, wherein the electronic system follows UFS 4.0 standard.

12. The electronic system of claim 11, wherein the storage regions are submission queues for storing the command.

13. The electronic system of claim 12, further comprising a multi-circular queue comprising the storage regions.

14. The electronic system of claim 11, wherein the storage regions respectively comprise a register, and the abort information is from one of the registers.

15. The electronic system of claim 10,
wherein the step (a) writes storage region information to the command while storing the command to the storage regions;
wherein the step (c) checks if the abort information and the target command are from the identical one of the storage regions according to the storage region information.

16. The electronic system of claim 10, further comprising:
recording storage region information for each one of the command by a processing circuit which controls the storage region;
wherein the step (c) checks if the abort information and the target command are from the identical one of the storage regions according to the storage region information.

17. The electronic system of claim 10, wherein the step (d) further comprises:
stopping fetching the command from the storage regions or stopping transmitting the command to the target device, if the result of the step (c) is yes.

18. The electronic system of claim 10, wherein the step (d) further comprises:
transmitting the target command to a target device and processing the target command by the target device if the result of the step (c) is no.
